(19) United States
(12) Patent Application Publication
(10) Pub. No.: US 2020/0324361 A1
(43) Pub. Date: Oct. 15, 2020

(54) ROLL BONDING OF DISSIMILAR METALS

(71) Applicant: Spur Industries Inc., Spokane, WA (US)

(72) Inventors: John W. Scelfo, Spokane Valley, WA (US); Tim Field, Spokane, WA (US); Gene A. Todhunter, Athol, ID (US)

(21) Appl. No.: 16/860,500

(22) PCT Filed: Oct. 29, 2018
(86) PCT No.: PCT/US2018/057974

§ 371 Date: Apr. 28, 2020

Related U.S. Application Data
(60) Provisional application No. 62/579,130, filed on Oct. 30, 2017.

(51) Int. Cl. B23K 20/04; B32B 15/01; B23K 20/26

(52) U.S. Cl. CPC B23K 20/04; B23K 2103/02; B23K 20/26; B32B 15/01

(57) ABSTRACT

A method of manufacturing a clad part comprising two metals is provided. The method includes roll bonding two metals to create the clad part. The roll bonding process may include cutting the two metals to a certain size, wherein one metal is wider than the other metal, preparing surfaces of the two metals, heating at least one of the metals, inserting the two metals into a rolling mill while positioning the two metals relative to one another.

### PRIORITY

This application is a national stage application of an international patent application PCT/US18/57974, filed Oct. 29, 2018 which claims priority to U.S. Provisional Application Ser. No. 62/579,130, filed on Oct. 30, 2017, entitled “Roll Bonding of Dissimilar Metals,” the entirety of which, is incorporated herein by reference.

### BACKGROUND

As metallurgical innovation progresses, there is a growing demand for metals to perform in ways that were previously impossible. For example, the automotive and aerospace industries benefit greatly from materials that are lightweight while continuing to provide consistent reliability and durability. This performance may be achieved through the bonding of dissimilar metals.

Typically, bonding two dissimilar metals has been achieved by use of explosion welding or roll bonding. Explosion welding comes with some limitations and disadvantages. For example, producing an explosion weld is limited to a very specific area because of the explosive nature of the process, which causes an enormous amount of disturbance to the surrounding environment. Therefore, explosion welding cannot be conducted within industrial environments, but must be conducted in remote places. Furthermore, the explosives used for explosion welding are highly regulated, making it difficult to store and use the explosives. Moreover, the size and shape of parts that can be made by explosion welding is limited. For instance, it is difficult or impossible to manufacture relatively thin parts using explosion welding due to the explosive nature of the process.

Therefore, there is an ongoing need for solutions that allow for creating strong bonds of dissimilar metals.

### BRIEF DESCRIPTION OF THE DRAWINGS

The detailed description references the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the components on a larger scale or differently shaped for the sake of clarity.

FIG. 1 a top plan view of an example embodiment of a bonded clad of dissimilar metals described herein.

FIG. 2A is a front view illustrating an example embodiment of a guide for positioning two metals at an entrance table of a rolling mill.

FIG. 2B is a front view illustrating a second example embodiment of a guide for positioning two metals at an entrance table of a rolling mill.

FIG. 2C is a front view illustrating a third example embodiment of a guide for positioning two metals at an entrance table of a rolling mill.

FIG. 3A is a schematic side view of the rolling mill as the two metals enter a set of rollers in the rolling mill.

FIG. 3B is a close-up view of the two metals as they are rolled into the bonded clad.

### DETAILED DESCRIPTION

### Overview

As discussed above, additional techniques are needed for bonding dissimilar metals. Explosion welding, while effective, comes with many disadvantages. Other forms of metal bonding and welding do not achieve the strength and uniformity of bond needed for some applications.

This application describes a roll bonding process that is capable of bonding metals. By roll bonding two dissimilar metals, the resultant clad part performs at a higher range of capabilities and characteristics than either of the two metals alone. For example, rather than having to choose between durability and weight, a client is now able to achieve both considerations with minimal sacrifice on one end or the other. As another example, composite clad parts may be constructed that have a uniform, seamless structure but possess different material properties in different portions of the clad part (e.g., one portion may be ferritic and thus magnetic while another portion may be non-ferritic and therefore not magnetic, different portions of the clad part may have different electrical and/or thermal conductivity properties, etc.). While this application generally describes the bonding of steel and aluminum, it is contemplated that other dissimilar or similar metals may be bonded through a similar process. In some examples, the process described herein provides a bond between two dissimilar metals that is stronger than the weaker of the two metals.

In some examples, a first metal may be roll bonded with a second metal. In some examples, the first metal may be different than the second metal. For example, the first metal may be a ferrous metal and the second metal may be a non-ferrous metal. However, it is also contemplated that one type of ferrous metal may be roll bonded with another type of ferrous metal and/or one type of non-ferrous metal may be roll bonded with a second type of non-ferrous metal. In some examples, the ferrous metal may be one of iron, cast iron, mild steel, carbon steel, stainless steel, high speed steel, etc. In some examples, the non-ferrous metal may be one of aluminum, copper, lead, nickel, tin, titanium, zinc, alloys thereof, etc. In one example, the ferrous metal may include steel and the non-ferrous metal may include aluminum. In some examples, the first metal may be magnetic and the second metal may be substantially non-magnetic. Some examples of magnetic metals include iron, cast iron, mild steel, carbon steel, ferritic stainless steel, martensitic stainless steel, high speed steel, nickel, etc. Some examples of non-magnetic metals include aluminum, austenitic stainless steel, copper, lead, tin, titanium, zinc, alloys thereof, etc. In one example, the first metal may comprise ferritic stainless steel and the second metal may comprise austenitic stainless steel. However, in other examples, other selections of ferrous, non-ferrous, magnetic, and/or non-magnetic metals are contemplated.

The process described below is one example implementation of a process to roll bond dissimilar metals. The operations described in this process may be rearranged, or omitted entirely. In other examples, additional steps may be added to the process. In some examples, the process may be partially automated while including human involvement. However, in other examples, the process may be completely automated or non-automated.

In some examples, the process may begin by receiving metal materials. The metal pieces may be cut to size prior to receiving the metal pieces or the metal pieces may be cut to size after they are received. In this example, at least one steel piece and at least one aluminum piece are received. However, in other examples, other types of metal pieces may be received. In some examples, a high purity aluminum piece may be used as one metal for the roll bonding process. For example, a 1000 series or 1100 series aluminum alloy may be used. However, in other examples other aluminum alloys with higher or lower purities may be used in the roll bonding process. In some examples, a structural steel may be used as a second metal in the roll bonding process. However, in other examples, other steel alloys may be used.

In some examples, once the aluminum pieces and the steel pieces have been received, the metal pieces are then cut to a predetermined size if they have not been cut prior to being received. In some examples, each metal piece may be cut to a predetermined length and width to achieve the desired dimensions for the resulting clad part. For example, the dimensions of the materials will change as the materials undergo the roll bonding process. Therefore, they metal pieces will be cut to predetermined dimensions prior to roll bonding to achieve the desired clad dimensions.

In some examples, when the metal pieces have been sized correctly, the metal pieces are then cleaned and washed. Cleaning and washing the metal pieces ensures that the bond surface is devoid of pollutants. Pollutants may include rust, dust, oils, sediment, cuttings, etc. In some examples, the metal pieces may be cleaned with a cleaner that does not leave a residue on the surface of the metal pieces. However, in other examples, a cleaner may be used that leaves a type of residue on the surfaces of the metal pieces. Such a residue may contribute to the bonding ability of the two metal pieces. A cleaner may be used that evaporates quickly to ensure quick drying of the surface before the next steps in the roll bonding process. In some examples, all surfaces of the metal piece may be washed and cleaned. However, in other examples, at least one surface may be washed and cleaned. In an example where less than all surfaces of the metal pieces will be washed and cleaned, at least the bonding surface will be washed and cleaned.

In some examples, the surfaces of the aluminum piece and the steel piece may be prepared for application. As mentioned above, in some examples, all surfaces of the metal pieces will be prepared for application. However, in other examples, at least one surface will be prepared. The at least one surface may include the bonding surfaces of both the aluminum piece and the steel piece.

Surface preparation may include brushing, sanding, sand blasting, etching (e.g., mechanical or acid etching), polishing, sintering, powder coating, plating, or the like. The one or more surfaces of the first metal and the second metal may be prepared using the same or different surface preparation operations.

In some examples, one or more surfaces of the first and/or second metals may be prepared by a sanding process. In some examples, one or more sanding stages may be implemented to prepare the one or more surfaces. For example, the one or more surfaces may be sanded first by a coarse grit sander and may be subsequently sanded by progressively finer sanders. The sanding process may become progressively more fine as the one or more surfaces undergo subsequent sanding stages. The sanding process may remove any particulate matter still on the surface of the one or more surfaces after the washing and cleaning stage. The sanding process may also remove any oxidation that is present on the one or more surfaces. In some examples, the sanding stages may use sanding grits between approximately 24 grit and approximately 1000 grit, between approximately 40 grit and approximately 800 grit, or between approximately 80 grit and approximately 640 grit. However, in other examples, other grits of sanding media may be used. For example, the sanding stages may include one or more of 24 grit, 40 grit, 60 grit, 80 grit, 100 grit, 104 grit, 150 grit, 180 grit, 220 grit, 260 grit, 320 grit, 360 grit, 400 grit, 420 grit, 460 grit, 500 grit, 520 grit, 560 grit, 600 grit, 620 grit, 660 grit, 700 grit, 800 grit, or 1000 grit sanders. The sanding media may include one or more of zirconia alumina, silicon carbide, aluminum oxide, diamond, sand, calcite, calcium carbonate, pumice, emery, etc., for example. In some examples, the sanding media may comprise sand paper, an abrasive fabric (e.g., belt, disk, or sheet), loose abrasive grit, abrasive powder, etc.

In some examples, one or more surfaces of the first and/or second metals may be prepared by a brushing process. For example, the one or more surfaces may be brushed by a stainless steel wire brush. However, in other examples, the one or more surfaces may be brushed by other metal type brushes or non-metal brushes, metal meshes, and/or abrasive fabrics. In some examples, the one or more surfaces may be brushed in more than one rotational directions. Brushing the one or more surfaces in multiple directions ensures that the piece is adequately prepared for the bonding stage of the process by removing oxidization from the one or more surfaces. In some examples, the one or more surfaces may be brushed at a rate of between about 500 and about 10,000 revolutions per minute. In some examples, the brushing stage of the process is conducted in a clean, well ventilated environment to ensure that brushed particles are cleared from the one or more surfaces.

In some examples, one or both of the metals may be heat treated. The heat treatment may be the same or different for the first and second metals. In some examples, the aluminum and/or steel may be placed in a convection furnace for a predetermined period of time sufficient for the meal to reach a generally uniform temperature throughout the piece. One having ordinary skill in the art will be able to calculate the necessary time to reach the particular temperature needed. The heat treatment softens the metal to ensure that the metals deform when compressed in the rolling mill and a proper bond is formed between the two metals. In some examples, one or both of the metals may be heated to or above a target temperature to ensure that the metal pieces are rolled at or around the target temperature. The temperatures for the different metals may be different and may be selected based upon the particular metals used, the thicknesses of the metal pieces, and/or other factors. In one example, one or both of the metal pieces may be heated to a temperature, between approximately 300 degrees Fahrenheit (° F.) and approximately 900° F., between approximately 500° F. and approximately 750° F.

In some examples, one or both of the metal pieces may be maintained at an ambient temperature. The ambient temperature may vary depending on the location that the roll bonding may be performed. However, in some examples, the ambient temperature may range between approximately 20° F. and approximately 104° F., between approximately 40° F. and approximately 100° F., between approximately 50° F. and approximately 90° F. In some examples, one or both metal pieces may be cooled to below ambient temperature. Maintaining the metal piece(s) at or below ambient temperature minimizes the oxidation of the bonding surface of the piece(s).

In some examples, after one or both of the metal pieces have reached a predetermined temperature of their respective heat treatments, the first metal piece may be placed directly on top of and in contact with the second metal piece. In an example where only one surface of each piece has been prepared for roll bonding, the prepared surface of each piece is placed directly in contact with the prepared service of the other piece. This is to increase the quality of the bond between the two pieces of metal. In some examples, there is no intermediary material placed between the aluminum piece and the steel piece. However, in other examples, intermediary material may be placed between the two pieces of metal. In some examples, the first metal piece is placed directly atop or in contact with the second metal piece within a threshold amount of time (e.g., within about 5 minutes) after the preparation of one or both of the pieces is complete. Placing the metal pieces in contact relatively quickly after surface preparation is complete helps to minimize oxidation or other contamination that may form or be deposited on the prepared surfaces. In some examples, one metal piece is heat treated and placed in contact with the second metal piece that has not been heat treated or has been subjected to a different heat treatment than the first metal piece.

In some examples, once the first metal piece has been placed in contact with the second metal piece, the two pieces are then introduced into a rolling mill. In some examples, the first metal piece and the second metal piece are introduced into the rolling mill at a substantially flat grade. For example, the first metal piece and the second metal piece may be introduced at a substantially tangential angle relative to the respective roller. However, in other examples, the first metal piece and the second metal piece may be introduced at a flat angle relative to the rolling mill or an angle other than flat. In some examples, the rolling mill may include at least one top roller and at least one bottom roller. In other examples, the rolling mill may include more than one roller on the top and or the bottom. The rollers may be spaced apart at a distance less than the final thickness of the resultant bonded clad part. For example, the top roller may be spaced apart from the bottom roller at a distance between approximately 0.60 mm to approximately 1.20 mm, or between approximately 0.75 mm to approximately 1.05 mm, less than the final thickness of the resultant bonded clad part. In some examples, a lubricant may be applied to top and/or bottom roller(s). The lubricant ensures that the metal piece(s) will not stick to the roller(s) as they move through the mill. Any suitable lubricant may be used. The rollers may be kept at or around an ambient temperature, in some examples, to ensure that the metals do not begin to stick to them. In some examples, the metal pieces may be rolled in a direction that is parallel to a direction in which the metal was originally rolled.

In some examples, the rolling mill may include one or more guides on or around the entrance table of the mill to properly align the first metal piece with respect to the second metal piece. For example, the first metal piece may be centered relative to the second metal piece. However, in other examples, the first metal piece may be aligned at a location other than centered relative to the second metal piece. The guides may comprise an inverted T-shape, in some examples. All or part of the top and/or bottom of the guides may be open. However, in other examples, other shaped guides may be used to achieve a predetermined alignment of the two metals. Still further, in other examples, the guides may be omitted from the rolling mill entirely.

Once the first metal piece and the second metal piece have been rolled through the rolling mill the resultant clad part is then removed from the mill and allowed to cool to ambient temperature in some examples. In some examples, the clad part is then pressed to ensure flatness of the clad part.

The clad part may then be cut to a final dimension in some examples. The final dimension may be specified by a consumer in some examples. The final dimension may include a length, width, and thickness.

In some examples, the clad part may undergo testing to ensure a proper bond has been formed between the aluminum piece and the steel piece. One such test may be a zero radius bend test in some examples. The zero radius bend test may show that the interface between the two metals has a higher strength than the weaker of the two metals. However, in other examples an “S” bend test may be conducted. Still further, in other examples, one or more tests may be conducted on the clad part, the one or more tests may or may not include the zero radius bend test and/or the “S” bend test.

### Example Illustration

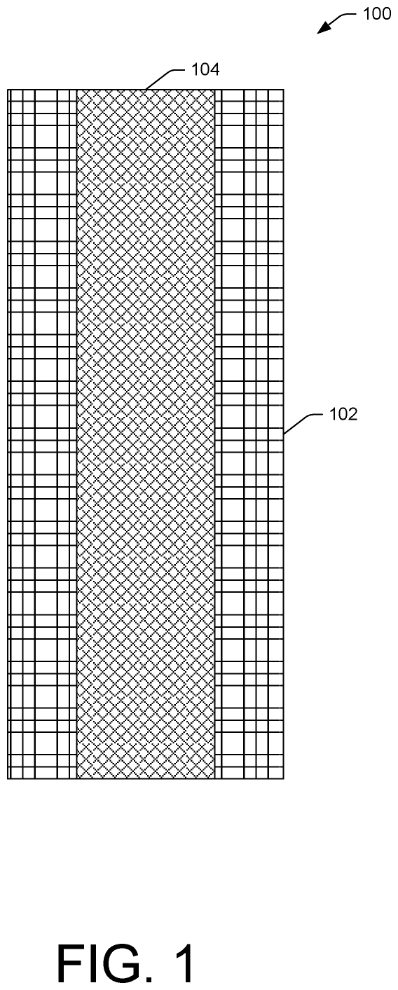

FIG. 1 is a top or plan view of an example of a clad part 100. The clad part shown in FIG. 1 is comprised of two metals. In some examples, the two metals may be different or they may be the same or similar. For example, the first metal 102 may be comprised of a ferrous, non-ferrous, magnetic, or non-magnetic metal and the second metal 104 may be comprised of a same or different ferrous, non-ferrous, magnetic, or non-magnetic metal. In some examples, the first metal 102 may be different than the second metal 104. For example, the first metal 102 may comprise a ferrous metal while the second metal 104 may comprise a non-ferrous metal. As another example, the first metal 102 may comprise a magnetic metal and the second metal 104 may comprise a non-magnetic metal. In some examples, the first metal 102 may include a steel alloy while the second metal 104 may include an aluminum alloy. However, in some examples, the first metal 102 and the second metal 104 may comprise the same type of metal. FIG. 1 depicts the second metal 104 centered relative to the first metal 102. However, in other examples, the second metal 104 may be aligned in an arrangement other than centered relative to the first metal 102 (e.g., aligned along one edge of both metals, offset from center by a particular distance, etc.). In some examples, the dimensions of the first metal 102 and the second metal 104 may be different than what is depicted in FIG. 1 or described above.

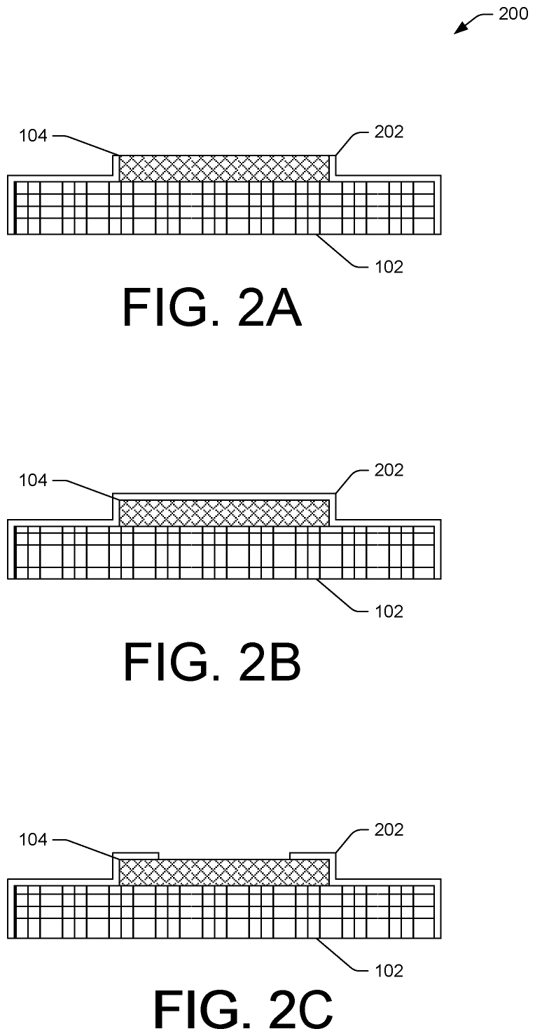

FIG. 2A depicts a front view illustrating an example of a guide 202 used to position the first metal 102 relative to the second metal 104 as it is introduced into the rolling mill. FIG. 2A depicts the guide 202 as an inverse T-shape, thus aligning the second metal 104 centered relative to the first metal 102. However, in other examples, the guide 202 may be shaped to align the second metal 104 and the first metal 102 in an alternate configuration. The guide 202 ensures that the first metal 102 and the second metal 104 do not follow the path of least resistance as the travel through the rolling mill. In FIG. 2A the bottom and the top of the guide 202 is open. However, in other examples, the top and/or bottom ends of the guide 202 may be completely open, completely closed, or partially closed. Two examples of partially closed guides are depicted in FIGS. 2B and 2C.

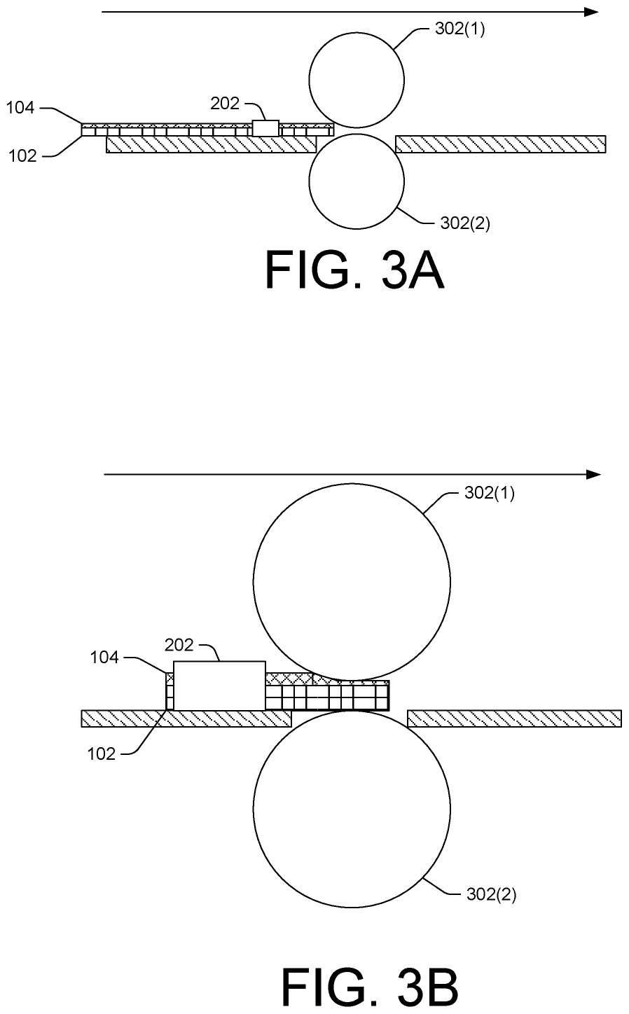

FIG. 3A depicts a side view of the first metal 102 and the second metal 104 as they prepare to enter the rolling mill 300. FIG. 3A depicts the rolling mill 300 including at least a top roller 302(1) and a bottom roller 302(2).

FIG. 3B depicts a close-up view of the first metal 102 and the second metal 104 as they are rolled into the bonded clad. FIG. 3B depicts that the rollers 302(1) and 302(2) are set at a distance less than a total thickness of the first metal piece 102 and the second metal piece 104.

### Example Clauses

A: A method of manufacturing a clad part of at least two dissimilar metals, the method comprising: cutting a piece of ferrous metal to a first size; cutting a piece of non-ferrous metal to a second size, the second size being different than the first size; preparing at least one surface of the piece of ferrous metal; preparing at least one surface of the piece of non-ferrous metal; heating the piece of non-ferrous metal; placing the at least one surface of the piece of non-ferrous metal directly on top of the at least one surface of the piece of ferrous metal; rolling the piece of non-ferrous metal and the piece of ferrous metal through a rolling mill, wherein the rolling comprises positioning the piece of non-ferrous metal relative to the piece of ferrous metal as the piece of non-ferrous metal and the piece of ferrous metal enter the rolling mill; and removing the clad part from the rolling mill.

B: The method according to paragraph A, wherein the first size is larger in at least one dimension than the second size.

C: The method according to any one of paragraphs A or B, wherein preparing the at least one surface of the piece of ferrous metal comprises: washing and cleaning the at least one surface of the piece of ferrous metal, and sanding the at least one surface of the piece of ferrous metal, the sanding comprising two or more progressive sanding stages, wherein preparing the at least one surface of the piece of non-ferrous metal comprises: washing and cleaning the at least one surface of the piece of non-ferrous metal, and brushing the at least one surface of the piece of non-ferrous metal, the brushing comprising brushing the at least one surface of the piece of non-ferrous metal in one or more directions.

D: The method according to any one of paragraphs A-C, wherein heating the piece of non-ferrous metal includes heating the piece of non-ferrous metal to achieve a uniform heat distribution.

E: The method according to any one of paragraphs A-D, wherein the piece of ferrous metal is at an ambient temperature prior to placing the at least one surface of the piece of non-ferrous metal on top of the at least one surface of the piece of ferrous metal.

F: The method according to any one of paragraphs A-E, wherein positioning the piece of non-ferrous metal relative to the piece of ferrous metal is performed by one or more guides on an entrance table of the rolling mill that center the piece of non-ferrous metal relative to the piece of ferrous metal.

G: The method according to any one of paragraphs A-F, wherein two or more rollers of the rolling mill are spaced apart less than a thickness of the clad part.

H: The method according to paragraph G, wherein the method further comprises lubricating at least one roller of the two or more rollers.

I: The method according to any one of paragraphs A-H, wherein the method further comprises: reducing a temperature of the clad part to an ambient temperature; flattening the clad part via pressing the clad part; and cutting one or more ends of the clad part to reduce the clad part a third size.

J: The method according to any one of paragraphs A-I, wherein positioning the piece of non-ferrous metal relative to the piece of ferrous metal includes centering the piece of non-ferrous metal relative to the piece of ferrous metal.

K: The method according to any one of paragraphs A-J, wherein the method further comprises testing the clad part via a zero-radius bend test at an interface between the piece of non-ferrous metal and the piece of ferrous metal.

L: The method according to paragraph F, wherein the one or more guiding rails comprise an inverted T-shaped guide including an open top and an open bottom.

M: The method according to any one of paragraphs A-L, wherein the method further comprises cutting the clad part to a third size.

N: The method according to paragraph M, wherein the third size comprises a length of about 2000 mm, a width of about 406 mm, and a thickness of about 11 mm.

O: The method according to any one of paragraphs A-N, wherein preparing the at least one surface comprises at least one of sanding, sand blasting, brushing, acid etching, polishing, sintering, powder coating, or plating.

P: The method according to paragraph C, wherein the sanding includes at least four stages and each stage of the at least four stages includes using one of 40 grit, 60 grit, 80 grit, 100 grit, 120 grit, 150 grit, 180 grit, 220 grit, 260 grit, 320 grit, 360 grit, 400 grit, 420 grit, 460 grit, 500 grit, 520 grit, 560 grit, 600 grit, 620 grit, 660 grit, 700 grit, 800 grit, or 1000 grit.

Q: The method according to paragraph C, wherein the sanding includes using a sanding media including at least one of zirconia alumina, silicon carbide, aluminum oxide, diamond, sand, calcite, calcium carbonate, pumice, or emery.

R: The method according to paragraph Q, wherein the sanding media comprises paper, fabric, loose grit, or powder.

S: The method according to any of one of paragraphs A-R, wherein heating the piece of non-ferrous metal includes heating the piece of non-ferrous metal to at least about 500 degrees F.

T: The method according to any one of paragraphs A-S, wherein heating the piece of non-ferrous metal includes heating the piece of non-ferrous metal to at least about 700 degrees F. and at most about 750 degrees F.

U: The method according to any one of paragraphs A-T, wherein the piece of non-ferrous metal comprises at least one of aluminum, copper, lead, nickel, tin, titanium, zinc, or an alloy thereof.

V: The method according to any one of paragraphs A-U, wherein the piece of ferrous metal comprises at least one of iron, cast iron, mild steel, carbon steel, stainless steel, high speed steel, or an alloy thereof.

W: The method according to any one of paragraphs A-V, wherein cutting the piece of ferrous metal to the first size comprises cutting the piece of ferrous metal to a first width and wherein cutting the piece of non-ferrous metal to the second size comprises cutting the piece of non-ferrous metal to a second width, the first width being wider than the second width.

X: The method according to any one of paragraphs A-W, wherein rolling further comprises introducing the piece of non-ferrous metal and the piece of ferrous metal into the rolling mill at a substantially flat grade.

### Conclusion

While various examples and embodiments are described individually herein, the examples and embodiments may be combined, rearranged and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A part including:
a first metal plate having a first width; and
a second metal plate having a second width, the second width being different than the first width; and
the part being formed by a method comprising:
cleaning at least one surface of the first metal plate and at least one surface of the second metal plate;
preparing the at least one surface of the first metal;
preparing the at least one surface of the second metal;
heating the second metal, wherein the heating includes heating the second metal to a uniform temperature throughout the second metal;
placing the at least one surface of the second metal in contact with the at least one surface of the first metal, wherein placing occurs within a predetermined threshold of time after the preparing the at least one surface of the first metal is complete and while the first metal is at ambient temperature; and
positioning, via one or more guides, the second metal relative to the first metal as the first metal and the second metal enter a rolling mill.

2. The part according to claim 1, wherein the method further comprises cutting the first metal to a first predetermined size and the second metal to a second predetermined size prior to cleaning the first metal and the second metal.

3. The part according to claim 1, wherein preparing the at least one surface of the first metal includes sanding the at least one surface of the first metal at two or more sanding stages.

4. The part according to claim 1, wherein preparing the at least one surface of the second metal includes brushing the at least one surface of the second metal plate, the brushing including a first brush direction and a second brush direction, wherein the first direction and the second direction are opposing directions.

5. The part according to claim 1, wherein heating the second metal includes placing the second metal within a convection furnace for a predetermined amount of time to achieve the uniform temperature.

6. The part according to claim 1, wherein the rolling mill includes guides that position the second metal relative to the first metal as the first metal and the second metal are inserted into the rolling mill.

7. The part according to claim 1, wherein the rolling mill includes at least a top roller and a bottom roller, the top roller including a lubricant.

8. The part according to claim 7, wherein the top roller and the bottom roller are spaced apart less than a thickness of the part.

9. The part according to claim 1, wherein a bond between the first metal and the second metal is capable of withstanding a zero-radius bend test at an interface between the first metal and the second metal.

10. The part according to claim 1, wherein the method further comprises pressing the part to flatten the part and cutting one or more ends of the clad part to a third predetermined size.

11. The part according to claim 7, wherein the top roller and the bottom roller are kept below a predetermined threshold temperature.

12. The part according to claim 1, wherein preparing the at least one surface of the first metal comprises sanding the at least one surface of the first metal, the sanding comprising two or more sanding stages.

13. The part according to claim 12, wherein the sanding includes at least four progressive sanding stages, each stage of the at least four progressive sanding stages using one of 40 grit, 60 grit, 80 grit, 100 grit, 120 grit, 150 grit, 180 grit, 220 grit, 260 grit, 320 grit, 360 grit, 400 grit, 420 grit, 460 grit, 500 grit, 520 grit, 560 grit, 600 grit, 620 grit, 660 grit, 700 grit, 800 grit, or 1000 grit.

14. The part according to claim 12, wherein the sanding includes using a sanding media including at least one of zirconia alumina, silicon carbide, aluminum oxide, diamond, sand, calcite, calcium carbonate, pumice, or emery.

15. The part according to claim 1, wherein the one or more guides comprise an inverted T-shaped guide including an open top and an open bottom.

16. A method of manufacturing a clad part of at least two dissimilar metals, the method comprising:
cutting a piece of ferrous metal to a first size;
cutting a piece of non-ferrous metal to a second size, the second size being different than the first size;
preparing at least one surface of the piece of ferrous metal;
preparing at least one surface of the piece of non-ferrous metal; heating the piece of non-ferrous metal;
placing the at least one surface of the piece of non-ferrous metal directly on top of the at least one surface of the piece of ferrous metal;
rolling the piece of non-ferrous metal and the piece of ferrous metal through a rolling mill, wherein the rolling comprises positioning the piece of non-ferrous metal relative to the piece of ferrous metal as the piece of non-ferrous metal and the piece of ferrous metal enter the rolling mill; and
removing the clad part from the rolling mill.

17. The method according to claim 16, wherein the first size is larger in at least one dimension than the second size.

18. The method according to claim 16, wherein preparing the at least one surface of the piece of ferrous metal comprises:
washing and cleaning the at least one surface of the piece of ferrous metal, and
sanding the at least one surface of the piece of ferrous metal, the sanding comprising two or more progressive sanding stages, wherein preparing the at least one surface of the piece of non-ferrous metal comprises:
washing and cleaning the at least one surface of the piece of non-ferrous metal, and
brushing the at least one surface of the piece of non-ferrous metal, the brushing comprising brushing the at least one surface of the piece of non-ferrous metal in one or more directions.

19. The method according to claim 16, wherein positioning the piece of non-ferrous metal relative to the piece of ferrous metal is performed by one or more guide rails on an entrance table of the rolling mill that center the piece of non-ferrous metal relative to the piece of ferrous metal.

20. The method according to claim 19, wherein the one or more guiding rails comprise an inverted T-shaped guide including an open top and an open bottom.
